(19) United States
(12) Patent Application Publication
(10) Pub. No.: US 2016/0004246 A1
(43) Pub. Date: Jan. 7, 2016

(54) PID CONTROLLER AND DATA COLLECTING METHOD

(71) Applicant: Azbil Corporation, Tokyo (JP)

(72) Inventors: Masato TANAKA, Tokyo (JP); Eisuke TOYODA, Tokyo (JP); Fumihiro SUGAWARA, Tokyo (JP)

(73) Assignee: Azbil Corporation, Tokyo (JP)

(21) Appl. No.: 14/791,797

(22) Filed: Jul. 6, 2015

(30) Foreign Application Priority Data
Jul. 7, 2014 (JP) 2014-139291

(51) Int. Cl. G05B 19/404

(52) U.S. Cl. CPC G05B 19/404; G05B 2219/37431

(57) ABSTRACT

A PID controller includes: a manipulated variable outputting portion that outputs, to a subject of control, a manipulated variable MV calculated by a manipulated variable calculating portion; a long cycle data storing portion that stores, with each first cycle, time series data for the process variable PV; a short cycle data recording portion that records temporarily, with each second cycle that is shorter than the first cycle, time series data for the process variable PV; and a short cycle data storing portion that reads out from the short cycle data recording portion, and stores, data for an interval wherein there has been a change of at least a prescribed amount in the process variable PV, when there has been a change of at least the prescribed amount in the process variable PV that is recorded in the short cycle data recording portion.

### CROSS REFERENCE TO RELATED APPLICATION

This application claims priority under 35 U.S.C. §119 to Japanese Patent Application No. 2014-139291, filed on Jul. 7, 2014, the entire content of which being hereby incorporated herein by reference.

### FIELD OF TECHNOLOGY

The present invention relates to a proportional-integral-derivative (“PID”) controller, such as a temperature controller, and, in particular, relates to a PID controller that is provided with a data collecting function.

### BACKGROUND

Temperature controllers that are equipped with PID controlling functions are used in order to control temperatures in heat treatment furnaces, and the like. In a temperature regulator, it is necessary to set a large number of parameters, such as PID parameters. The temperature regulator performs PID calculations using the PID parameters, to output a manipulated variable MV that will cause the measured temperature PV to go to the set point SP that is set to the target temperature. This makes it possible to cause the measured temperature PV (the process variable PV) to approach the target temperature (the set point SP). Consequently, setting of the PID parameters, and the like, is necessary and important.

However, the control result information (data for characteristic values in control response, such as the time to arrival at the set point, the amount of overshoot, and so forth) is useful information, as the result of control for the actual control target, when ascertaining states wherein there are problems in control, and when adjusting the PID parameters. Because of this, a function is executed wherein characteristic values for the control response within the temperature controller are calculated, and are stored within the temperature controller, as the series of control operations, such as heating and cooling, are performed. See, for example, Japanese Unexamined Patent Application Publication No. 2009-217439 (the “JP '439”). On the other hand, there are also devices, such as data loggers, that collect and record all measured data. See, for example, Japanese Unexamined Patent Application Publication No. 2008-286603 (the “JP '603”). The data collecting functions described in the JP '439 and the JP '603 enable the characteristic values for the control response in PID control, or all time series data, to be collected, to be subject to monitoring, and to be processed as subject to analysis.

In the temperature control, if there is only a series of control operations, such as ramping the temperature up and down, this will be insufficient for efficient information collection. Moreover, because of the limitation in That is, in the feature quantity calculating function that is disclosed in the JP '439, there is a limit to the amount of information that can be stored, and thus it is insufficient. On the other hand, with the data logger disclosed in the JP '603, information that is not required for control operations is included, causing the amount of data that is collected to be too large, complicating the handling thereof, which is inconvenient. Consequently, it is desirable in an effective information collecting function that is specialized for control operations to have an improved function that is not too complex and wherein the information deficiency is not too great. In particular, there is the need for improvements for broader use in specialty situations, rather than just for handling ramping of temperatures up and down.

A dot recorder for extracting and recording, at discontinuous times with a prescribed period, is used as a data recording device in conjunction with a temperature recorder that is a typical example of a simple PID controller. For the control operation by a temperature controller, typically a period for collecting time series data (the point recording period) in a transitional state is set in advance on the somewhat long side with adequate accuracy, given the characteristics of that which is being controlled. In particular, in the case of PID calculations, the nature of the control operation is generally easy to predict. Consequently, in order to prevent the amount of data collected from becoming excessive, and to prevent the handling thereof from becoming complex, first the use of this type of long cycle data collection is envisioned. In this case, in the long cycle data collection the recording will the inadequate if there is a change that is faster than anticipated in the data between the periodic intervals. That is, if the data collecting period is too long, then there will be a problem in that data collecting omissions will occur more than anticipated.

The present invention was created in order to solve the problem set forth above, and an aspect thereof is to provide a PID controller, and data collecting method, able to reduce errors in data collection resulting from an unexpectedly fast change in a process variable PV, assuming that it will be incorporated into low-cost production such as with a simple PID controller, such as a temperature controller

### SUMMARY

A PID controller according to the present invention includes: a manipulated variable calculating portion that calculates a manipulated variable MV based on a set point SP and a process variable PV through a PID control calculation; a manipulated variable outputting portion that outputs, to a subject of control, the manipulated variable MV calculated by the manipulated variable calculating portion; a long cycle data storing portion that stores, with each first cycle, time series data for the process variable PV; a short cycle data recording portion that records temporarily, with each second cycle that is shorter than the first cycle, time series data for the process variable PV; and a short cycle data storing portion that reads out from the short cycle data recording portion, and stores, data for an interval wherein there has been a change of at least a prescribed amount in the process variable PV, only when there has been a change of at least the prescribed amount in the process variable PV that is recorded in the short cycle data recording portion.

In one structural example of a PID controller according to the present invention, when, during the first period, a difference between a maximum value and a minimum value of the process variable PV, recorded in the short cycle data recording portion, is at least equal to a prescribed value for a prescribed process variable, this is defined as a change of at least a prescribed amount in the process variable PV, and data in the first period wherein there has been this change of at least the prescribed amount are read out from the short cycle data recording portion and saved.

In one structural example of a PID controller according to the present invention, the first period has a value of a times the integrating time TI in the PID parameters.

In one structural example of a PID controller according to the present invention, the prescribed value for the process variable for detecting a change of at least a prescribed amount in the process variable PV has a value of β times the proportional band PB in the PID parameters.

Moreover, one structural example of a PID controller according to the present invention further includes: a reading directing portion that directs the operator to use a higher-level device to read in data that has been stored by the short cycle data storing portion when the data that has been stored by the short cycle data storing portion arrives at an amount of data commensurate with at least a prescribed amount of time.

Moreover, in one structural example of a PID controller according to the present invention: the long cycle data storing portion further stores, with each first cycle, time series data for the manipulated variable MV and time series data for the set point SP; the short cycle data recording portion further records temporarily, with each second cycle, time series data for the manipulated variable MV and time series data for the set point SP; and the short cycle data storing portion further reads out, from the short cycle data recording portion, and stores, time series data for the manipulated variable MV and time series data for the set point SP when there has been a change of at least a prescribed amount in the process variable PV.

A data collecting method according to the present invention includes: a manipulated variable calculating step for calculating a manipulated variable MV based on a set point SP and a process variable PV through a PID control calculation; a manipulated variable outputting step for outputting, to a subject of control, the manipulated variable MV calculated in the manipulated variable calculating step; a long cycle data storing step for storing, with each first cycle, time series data for the process variable PV; a short cycle data recording step for recording temporarily, with each second cycle that is shorter than the first cycle, time series data for the process variable PV; and a short cycle data storing step for reading out from data that has been recorded in the short cycle data recording step, and for storing, data for an interval wherein there has been a change of at least a prescribed amount in the process variable PV, only when there has been a change of at least the prescribed amount in the process variable PV that is recorded in the short cycle data recording step.

Given the present invention, data for an interval wherein there is a change in the process variable PV beyond that which is prescribed is read out, from the short cycle data recording portion, and stored only when there is a change that is beyond that which is prescribed in the process variable PV that is recorded in the short cycle data recording portion, and thus when the amount of change in a process variable PV during a single period is remarkable, or when there is a remarkable maximum or minimum in the process variable PV during a single period, it is possible to collect data without omission, thus making it possible to reduce omissions in data collection that result from a change in the process variable PV that is faster than that which is envisioned.

Moreover, the present invention enables a reduction in the overhead on the operator through carrying out PID controller set-up operations through setting the first cycle the value of a times the integrating time interval TI in the PID parameters.

Moreover, the present invention makes it possible to reduce the overhead on the operator who carries out the operation for setting up the PID controller, through having the process variable prescribed value, for detecting a change that is greater than a prescribed value in the process variable PV, be a value that is β times the proportional band PB of the PID parameter.

Moreover, the present invention can communicate to the operator that the remaining capacity for storing data in the short cycle data storing portion is running out, through prompting the operator to read in, using a higher-level device, the data that is stored in the short cycle data storing portion when the data stored in the short cycle data storing portion has arrived at an amount of data that is equal to or greater than an amount commensurate with a prescribed amount of time.

### BRIEF DESCRIPTIONS OF THE DRAWINGS

FIG. 1 is a block diagram illustrating a structure for a PID controller according to an example according to the present disclosure.

FIG. 2 is a block diagram illustrating a configuration for a heating device according to an example according to the present disclosure.

FIG. 3 is a flow chart illustrating the operation of a PID controller according to an example according to the present disclosure.

FIG. 4 is a diagram for explaining the data collecting operation of the PID controller according to an example according to the present disclosure.

### DETAILED DESCRIPTION

The present invention, based on discovery of the problem set forth above, focuses on the fact that that which is outside of expectations generally occurs seldomly in terms of time, to arrive at the use of cases wherein a change that is greater than a prescribed value has occurred in a process variable PV adjusting instrument, in order to expand the scope of application in specialty situations. The long cycle, which is the data collection period that is carried out conventionally, and the prescribed value for detecting a change in the process variable PV that is greater than that which is prescribed, can be determined based on PID parameters.

Specifically, short cycle data is recorded temporarily during the long cycle intervals, and the short cycle data, which has been recorded temporarily, is only stored if, during the long cycle period, there is a change in the process variable PV that is greater than that which is prescribed. Doing this makes it possible to reduce data collection omissions that occur as a result of there being a change that is unanticipated in the process variable PV.

Note that while the use of a data collecting function within a simple PID controller, such as a temperature controller, makes it possible to reliably capture rapid changes in the control system, the storage capacity of the PID controller is limited. Consequently, preferably there is both a function for notifying an operator so as to read in data through a higher-level device (for example, a PC (personal computer)) that is able to secure adequate storage capacity, and a function that transfers data to the higher-level device automatically to return the data region of the PID controller into a state wherein overwriting is allowed.

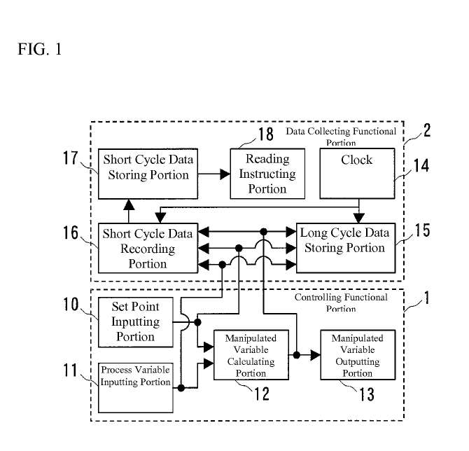

Forms for carrying out the present disclosure will be explained below in reference to the figures. FIG. 1 is a block diagram illustrating a structure for a PID controller according to an example according to the present disclosure. The PID controller includes a controlling functional portion 1, which is a typical structure that is conventionally provided in a PID controller, and a data collecting functional portion 2, which is a distinctive structure in the present example.

The controlling functional portion 1 is provided with: a set point inputting portion 10 for inputting a set point SP from outside of the controller; a process variable inputting portion 11 for inputting a process variable PV from a measurement instrument; a manipulated variable calculating portion 12 for calculating a manipulated variable MV based on the set point SP and the process variable PV through a PID control calculation; and a manipulated variable outputting portion 13 for outputting the manipulated variable MV to outside of the controller.

The data collecting functional portion 2 includes: a clock 14 for measuring the current date and time; a long cycle data storing portion 15 for storing, with each first cycle, time series data for the process variable PV, time series data for a manipulated variable MV, and time series data for a set point SP; a short cycle data recording portion 16 for recording temporarily, with each second cycle, which is shorter than the first cycle, time series data for the process variable PV, time series data for the manipulated variable MV, and time series data for the set point SP; a short cycle data storing portion 17 for reading out, from the short cycle data recording portion 16, and storing data, in the first cycle wherein there has been a change of equal to or greater than a prescribed value in the process variable PV, only in such a case as there has been a change that is greater than or equal to a prescribed value in the process variable PV that is recorded in the short cycle data recording portion 16 during the first cycle; and a reading directing portion 18 for directing the operator to read in, through a higher-level device, data that is stored in the short cycle data storing portion 17, when the data stored in the short cycle data storing portion 17 has arrived at data commensurate with at least a prescribed amount of time.

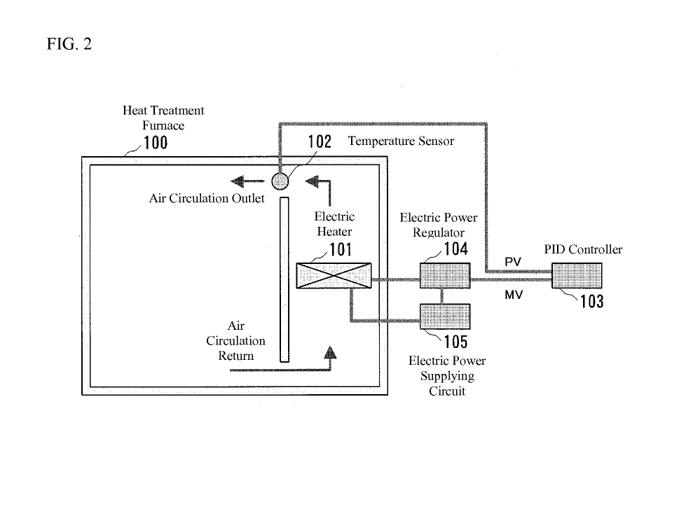

FIG. 2 is a block diagram illustrating one configuration of a heating controlling device to which the present example is applied. The heating controlling device is structured from a heat treatment furnace 100 for heating a heating object that is subject to treatment; an electric heater 101; a temperature sensor 102 for measuring the temperature within the heat treatment furnace 100; a PID controller 103 for controlling the temperature within the heat treatment furnace 100; a power regulator 104; and a power supplying circuit 105.

The PID controller 103 calculates a manipulated variable MV so that a process variable PV (the temperature) that is measured by a temperature sensor 102 will go to a set point SP. The set point SP is set by an operator, for example. The power regulator 104 determines the electric power in accordance with the manipulated variable MV, and supplies, to an electric heater 101 through the power supplying circuit 105, the power that has been determined. In this way, the PID controller 103 controls the temperature of the object that is heated within the heat treatment furnace 100. The controlling functional portion 1 and the data collecting functional portion 2 of FIG. 1 are built into the PID controller 103.

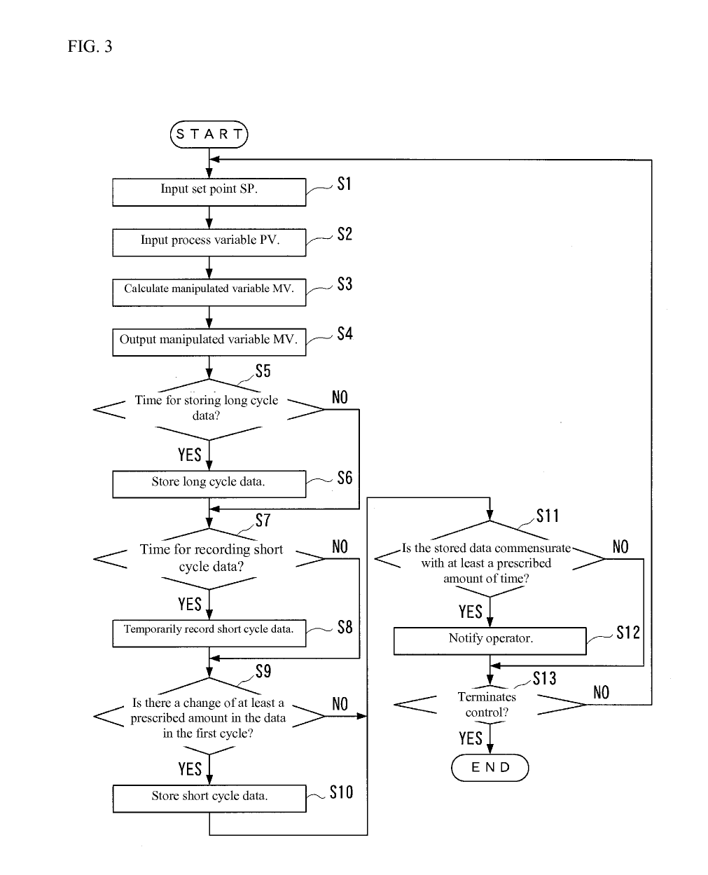

The operation of the present example will be explained next in reference to FIG. 3. The SP is set by an operator, or the like, and is inputted through the set point inputting portion 10 into the manipulated variable calculating portion 12, the long cycle data storing portion 15, and the short cycle data recording portion 16 (Step S1 in FIG. 3).

The process variable PV is measured by a measuring instrument (for example, the temperature sensor 102 in FIG. 2), and is inputted through the process variable inputting portion 11 into the manipulated variable calculating portion 12, the long cycle data storing portion 15, and the short cycle data recording portion 16 (Step S2 in FIG. 3).

The manipulated variable calculating portion 12 calculates a manipulated variable MV based on a set point SP and a process variable PV through the PID control calculation such as through the following transfer function equation (Step S3 in FIG. 3):

MV=(100/PB) {1+(1/TIs)+TDs} (SP−PV) (1)

In Equation (1), PB is a proportional band, TI is an integrating time, TD is a differentiating time, and s is the Laplace operator.

The manipulated variable outputting portion 13 outputs, to the controlled subject, the manipulated variable MV that has been calculated by the manipulated variable calculating portion 12 (FIG. 3, Step S4). In the example shown in FIG. 2, an electric power regulator 104 is the actual output destination for the manipulated variable MV.

Following this, the long cycle data storing portion 15, when the time is reached for the long cycle data to be stored (YES in Step S5 in FIG. 3), stores, data to be collected, the process variable PV that is inputted from the process variable inputting portion 11, the manipulated variable MV that is calculated by the manipulated variable calculating portion 12, and the set point SP that is inputted through the set value inputting portion 10 (Step S6 in FIG. 3). At this time, the long cycle data storing portion 15 records the current time information, obtained from the clock 14, in addition to the data set including the process variable PV, the manipulated variable MV, and the set point SP.

The long cycle data storing portion 15 stores data with each first cycle T1 that is longer than the control interval. Consequently, when the control operation continues and the procedures in Step S5 and S6 are repeated with each first cycle T1, time series data for the process variable PV, time series data for the manipulated variable MV, and time series data for the set point SP are stored in the long cycle data storing portion 15.

On the other hand, the short cycle data recording portion 16, when the time is reached for the short cycle data to be recorded (YES in Step S7 in FIG. 3), records temporarily, data to be collected, the process variable PV that is inputted from the process variable inputting portion 11, the manipulated variable MV that is calculated by the manipulated variable calculating portion 12, and the set point SP that is inputted through the set value inputting portion 10 (Step S8 in FIG. 3). At this time, the short cycle data recording portion 16 records the current time information, obtained from the clock 14, in addition to the data set including the process variable PV, the manipulated variable MV, and the set point SP.

The short cycle data recording portion 16 records data with each second cycle T2, which is either identical to the control interval or longer than the control interval and which is shorter than the first cycle T1 (T2<T1). Consequently, when the control operation continues and the procedures in Step S7 and S8 are repeated with each second cycle T2, time series data for the process variable PV, time series data for the manipulated variable MV, and time series data for the set point SP are recorded in the short cycle data recording portion 16.

Following this, the short cycle data storing portion 17 reads out, from the short cycle data recording portion 16, and then stores, the data (the time series data for the process variable PV, the time series data for the manipulated variable MV, and the time series data for the set point SP) in the first cycle T1 wherein there has been a change of at least a prescribed value in the process variable PV (Step S10 in FIG. 3) only if there has been a change of at least a prescribed amount in the process variable PV that is recorded in the short cycle data recording portion 16 in the first cycle T1 (YES in Step S9 in FIG. 3). That is, fundamentally the timing with which there is storing to the short cycle data storing portion 17 should be about the same as the timing for storing the long cycle data, or slightly delayed therefrom, where the data that is stored in the short cycle data storing portion 17 is all of the data that is recorded in the short cycle data recording portion 16 in the first cycle T1 interval.

Here the change of at least the prescribed amount in the process variable PV refers to the difference between the maximum value and the minimum value of the process variable PV recorded in the short cycle data recording portion 16 during the first cycle T1 being at least equal to a prescribed value PVth for the prescribed process variable. Consequently, when there is a maximum for the process variable PV that is recorded in the short cycle data recording portion 16 in the first cycle T1, in the short cycle data storing portion 17 that maximum becomes a candidate for a maximum value, and when the difference from the minimum value is at least equal to the prescribed value PVth for the process variable, then this is defined as there having been a change of at least the prescribed amount in the process variable PV, and the data that is recorded in the short cycle data recording portion 16 in the first cycle T1 (the time series data for the process variable PV, the time series data for the manipulated variable MV, and the time series data for the set point SP), are read out from the short cycle data recording portion 16 and stored.

Moreover, when there is a minimum for the process variable PV that is recorded in the short cycle data recording portion 16 in the first cycle T1, in the short cycle data storing portion 17 that minimum becomes a candidate for a minimum value, and when the difference from the maximum value is at least equal to the prescribed value PVth for the process variable, then this is defined as there having been a change of at least the prescribed amount in the process variable PV, and the data that is recorded in the short cycle data recording portion 16 in the first cycle T1 (the time series data for the process variable PV, the time series data for the manipulated variable MV, and the time series data for the set point SP), are read out from the short cycle data recording portion 16 and stored.

Moreover, if the data for the process variable PV that is recorded in the short cycle data recording portion 16 in the first cycle T1 is monotonically decreasing data, then a maximum value and a minimum value will exist, and thus, in the short cycle data storing portion 17, if the difference between the maximum value in the minimum value for the process variable PV recorded in the short cycle data recording portion 16 during the first cycle T1 is at least equal to the prescribed value PVth for the process variable, then this is defined as there having been a change of at least the prescribed amount in the process variable PV, so the data that is included in the interval between the maximum value and the minimum value is read out from the short cycle data recording portion 16 and saved.

Moreover, if the data for the process variable PV that is recorded in the short cycle data recording portion 16 in the first cycle T1 is monotonically increasing data, then in the short cycle data storing portion 17, if the difference between the maximum value in the minimum value for the process variable PV recorded in the short cycle data recording portion 16 during the first cycle T1 is at least equal to the prescribed value PVth for the process variable, then this is defined as there having been a change of at least the prescribed amount in the process variable PV, so the data that is included in the interval between the maximum value and the minimum value is read out from the short cycle data recording portion 16 and saved.

The difference between the temporary recording of data by the short cycle data recording portion 16 and the storing of data by the long cycle data storing portion 15 and the short cycle data storing portion 17 is that overwriting of data is allowed in the short cycle data recording portion 16, so that when the upper limit of the storage capacity for the short cycle data recording portion 16 is reached, the old data is overwritten sequentially with new data, while, in contrast, in the long cycle data storing portion 15 and the short cycle data storing portion 17, overwriting of data is prohibited, so that it is not possible to store data without first removing data that has been stored when the upper limit of the storage capacity is reached. The storage capacities for the short cycle data recording portion 16 and the short cycle data storing portion 17 should be at least capacities that are larger than the amount of short cycle data commensurate with the time of the long cycle (the first cycle T1).

When the data stored in the short cycle data storing portion 17 has reached an amount of data that is at least equal to the amount of data for a prescribed amount of time (Step S11 in FIG. 3), the reading directing portion 18 prompts the operator to read out, using a higher-level device (for example, a PC) the short cycle data that is stored in the data storing portion 17 (Step S12 in FIG. 3). The prompting method may be a method such as, for example, a blinking or illuminated LED that enables the operator to identify the prompt.

The processes in Step S1 through S12 as described above are repeated at each control interval until the control is terminated through, for example, an instruction from an operator (YES in Step S13 in FIG. 3).

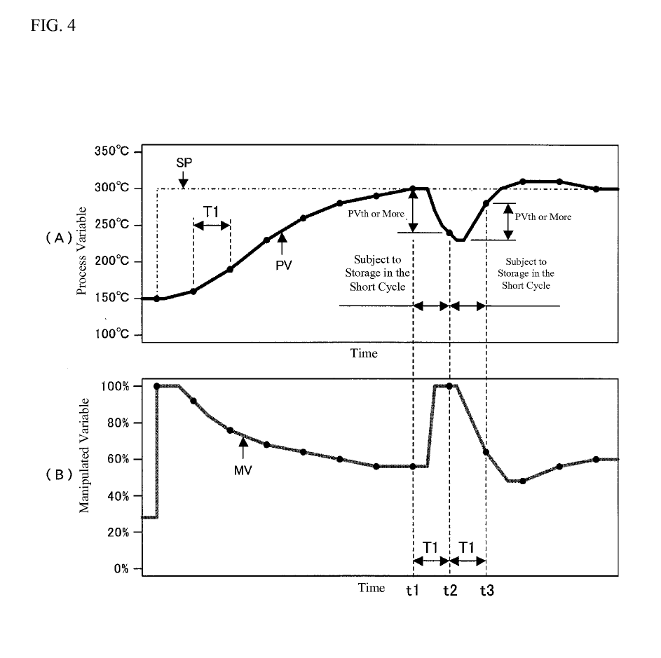

FIG. 4 (A) and FIG. 4 (B) are diagrams for explaining the operations in collecting data with a PID controller according to the present example, where FIG. 4 (A) illustrates one example of variation in the process variable PV, and FIG. 4 (B) illustrates one example of variation in the manipulated variable MV. The vertical axis in FIG. 4 (A) is the process variable PV, and the horizontal axis is time, where the vertical axis in FIG. 4 (B) is the manipulated variable MV, and the horizontal axis is time. Here the explanation will assume that the set point SP is a temperature set point, and the process variable PV is a temperature measurement, in a case such as, for example, collecting data in the heat treatment furnace in FIG. 2. As described above, T1 is a first cycle (long cycle) over which the long cycle data storing portion 15 stores data.

In the example in FIG. 4 (A) and FIG. 4 (B), when the set point SP is changed from 150° C. to 300° C., the process variable PV increases, but noise that is not anticipated is produced so that in the first cycle T1 (long cycle) from time t1 to time t2, the difference between the maximum value (the process variable PV at time t1) and the minimum value (the process variable PV at time t2) will be at least as great as the prescribed value PVth for the process variable, and thus all of the data in the first cycle T1, from time t1 until time t2, will be stored in the short cycle data storing portion 17. Moreover, in the first cycle T1 (long cycle) from time t2 until time t3, the difference between the minimum point (the minimum value) and the maximum value (the process variable PV at time t3) is greater than or equal to the prescribed value PVth for the process variable, so all of the data for the first cycle T1, from time t2 to time t3, will be stored in the short cycle data storing portion 17.

It is necessary to store the short cycle data when there is, for example, noise of a frequency that is higher than that of the frequency characteristics of the control operation (which can be calculated by the nature of the PID calculations). Consequently, if the long cycle (the first cycle T1) is set to a times the integration time in the PID parameters (T1=αTI, where, for example, α=0.5), and the prescribed value PVth for the process variable is set to β times the proportional band PB of the PID parameter (PVth=0 PB, where, for example, β=0.2), it is then possible for the operator to set these appropriately without placing a burden on the operator.

In the present example, data for the interval wherein there has been the change of at least the prescribed amount in the process variable PV is read out from the short cycle data recording portion 16 and stored only when there has been a change of at least the prescribed amount in the process variable PV that is recorded in the short cycle data recording portion 16 during the first cycle T1, and thus it is possible to collect data, without omission, when there has been a significant amount of change in the process variable PV within a long period or when there is a remarkable maximum point or minimum point for the process variable PV during the long period. That is, it possible to reduce data collection omissions that occur as a result of there being a change that is unanticipated in the process variable PV.

Moreover, while in the present example a reading directing portion 18 is provided in the data collecting functional portion 2, automatic transferring means may be provided instead. The automatic transferring means transfer, through a communication network to a higher-level device, the data that has been stored in the short cycle data storing portion 17 when the amount of data stored in the short cycle data storing portion 17 arrives at data commensurate with at least a prescribed amount of time, and remove the data that has been stored in the short cycle data storing portion 17. This makes it possible to return the short cycle data storing portion 17 to a state wherein the data can be overwritten.

Moreover, in the present example the short cycle data recording portion 16 records time series data for the process variable PV, time series data for the manipulated variable MV, and time series data for the set point SP, and the long cycle data storing portion 15 and the short cycle data storing portion 17 store time series data for the process variable PV, time series data for the manipulated variable MV, and time series data for the set point SP; however, recording/storing of the time series data for the manipulated variable MV and the time series data for the set point SP are not required conditions in the present invention. Instead, the short cycle data recording portion 16 need record only the time series data for the process variable PV, and the long cycle data storing portion 15 and the short cycle data storing portion 17 need store only time series data for the process variable PV.

The PID controller described in the present example can be embodied through a computer that is provided with a CPU (Central Processing Unit), a memory device, and an interface, and a program for controlling these hardware resources. The CPU executes the processes described in the present example in accordance with a program that is stored in the storage device.

The present invention can be applied to PID controllers that are provided with data collection functions.

1: A PID controller, comprising:
a manipulated variable calculating portion that calculates a manipulated variable MV based on a set point SP and a process variable PV through a PID control calculation;
a manipulated variable outputting portion that outputs, to a subject of control, the manipulated variable MV calculated by the manipulated variable calculating portion;
a long cycle data storing portion that stores, with each first cycle, time series data for the process variable PV;
a short cycle data recording portion that records temporarily, with each second cycle that is shorter than the first cycle, time series data for the process variable PV; and
a short cycle data storing portion that reads out from the short cycle data recording portion, and stores, data for an interval wherein there has been a change of at least a prescribed amount in the process variable PV, when there has been a change of at least the prescribed amount in the process variable PV that is recorded in the short cycle data recording portion.

2: The PID controller as set forth in claim 1, wherein:
when, during the first cycle, a difference between a maximum value and a minimum value of the process variable PV, recorded in the short cycle data recording portion, is at least equal to a prescribed value for a prescribed process variable, this is defined as a change of at least a prescribed amount in the process variable PV, and data in the first cycle wherein there has been this change of at least the prescribed amount are read out from the short cycle data recording portion and saved.

3: The PID controller as set forth in claim 1, wherein:
the first cycle has a value of a times the integrating time TI in the PID parameters.

4: The PID controller as set forth in claim 1, wherein:
the prescribed value for the process variable for detecting a change of at least a prescribed amount in the process variable PV has a value of β times the proportional band PB in the PID parameters.

5: The PID controller as set forth in claim 1, further comprising:
a reading instructing portion that directs an operator to read in, by a higher-level device, data stored in the short cycle data storing portion when the data stored in the short cycle data storing portion has arrived at the amount of data commensurate with a prescribed amount of time.

6: The PID controller as set forth in claim 1, wherein:
the long cycle data storing portion further store, with each first cycle, time series data for the manipulated variable MV and time series data for the set point SP;
the short cycle data recording portion further record temporarily, with each second cycle, time series data for the manipulated variable MV and time series data for the set point SP; and
the short cycle data storing portion further read out, from the short cycle data recording portion, and store, time series data for the manipulated variable MV and time series data for the set point SP when there has been a change of at least a prescribed amount in the process variable PV.

7: A data collecting method comprising:
a manipulated variable calculating step for calculating, by a manipulated variable calculating portion, a manipulated variable MV based on a set point SP and a process variable PV through a PID control calculation;
a manipulated variable outputting step for outputting by a manipulated variable outputting portion to a subject of control, the manipulated variable MV calculated in the manipulated variable calculating step;
a long cycle data storing step for storing at a long cycle data storing portion, with each first cycle, time series data for the process variable PV;
a short cycle data recording step for recording temporarily at a short cycle data recording portion, with each second cycle that is shorter than the first cycle, time series data for the process variable PV; and
a short cycle data storing step for reading out, by a short cycle data storing portion, from data that has been recorded in the short cycle data recording step, and for storing at the short cycle data storing portion, data for an interval wherein there has been a change of at least a prescribed amount in the process variable PV, when there has been a change of at least the prescribed amount in the process variable PV that is recorded in the short cycle data recording step.

8: The data method as set forth in claim 7, wherein:
when, during the first cycle, a difference between a maximum value and a minimum value of the process variable PV, recorded in the short cycle data recording step, is at least equal to a prescribed value for a prescribed process variable, this is defined as a change of at least a prescribed amount in the process variable PV, and data recorded in the short cycle data recording step in the first cycle wherein there has been this change of at least the prescribed amount are read out and saved.

9: The data collecting method as set forth in claim 7, further including:
the first cycle has a value of a times the integrating time TI in the PID parameters.

10: The data collecting method as set forth in claim 7, wherein:
the prescribed value for the process variable for detecting a change of at least a prescribed amount in the process variable PV has a value of β times the proportional band PB in the PID parameters.

11: The data collecting method as set forth in claim 7, further including:
a reading directing step for directing, by a reading directing portion, the operator to use a higher-level device to read in data that has been stored in the short cycle data storing step when the data that has been stored in the short cycle data storing step arrives at an amount of data commensurate with at least a prescribed amount of time.

12: The data collecting method as set forth in claim 7, wherein:
the long cycle data storing step includes a step for storing, which each first cycle, time series data for the manipulated variable MV and time series data for the set point SP; and
the short cycle data recording step further includes a step for recording temporarily, which each second cycle, time series data for the manipulated variable MV and time series data for the set point SP; and
the short cycle data storing step further includes a step for reading out, from the data recorded in the short cycle data recording step, and storing, time series data for the manipulated variable MV and time series data for the set point SP when there has been a change of at least a prescribed amount in the process variable PV.
